(19) United States
(12) Patent Application Publication
(10) Pub. No.: US 2010/0290235 A1
(43) Pub. Date: Nov. 18, 2010

(54) Light Condensing Structure for Illuminating Device

(76) Inventors: Chih-Hung Wei, Tucheng City (TW); Ming Chang Wu, Tucheng City (TW); Chih-Chun Wen, Tucheng City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/464,942

(22) Filed: May 13, 2009

(51) Int. Cl. F21V 3/00; F21S 6/00

(52) U.S. Cl. 362/311.02; 362/257; 362/311.01

(57) ABSTRACT

A light condensing structure for illuminating device includes a lamp shade; an optical unit located at an open end of the lamp shade and provided on one of two opposite sides with a plurality of concentric annular light condensing sections, each of which has an upward tapered cross-sectional shape; and a light-emitting element mounted in the lamp shade to face toward the other side of the optical unit. Divergent lights from the light-emitting element can be totally reflected (refracted) by the light condensing sections of the optical unit, so that an increased illuminating brightness can be achieved for the illuminating device.

### FIELD OF THE INVENTION

The present invention relates to a light condensing structure for illuminating device, and more particularly to a light condensing structure that enables divergent lights from a light-emitting element to be totally reflected (refracted) by a plurality of light condensing sections of an optical unit to thereby increase the illuminating brightness of an illuminating device.

### BACKGROUND OF THE INVENTION

A conventional illuminating device generally includes a lamp shade and a light-emitting element mounted in the lamp shade. Lights from the light-emitting element are either directly irradiated on or first reflected by the lamp shade before being projected to an external environment, so as to provide necessary illumination.

While the conventional illuminating device is able to provide necessary illumination, the lamp shade thereof is not provided with any structure or design capable of reflecting and/or condensing light. In the event the light-emitting element emits divergent lights due to an irradiating property thereof, the divergent lights would become scattered without being effectively condensed. In this case, the illuminating device can only provide diffused lights and a relatively weak brightness, and fails to satisfy the illumination requirement in practical use thereof.

### SUMMARY OF THE INVENTION

A primary object of the present invention is to provide alight condensing structure that enables divergent lights from a light-emitting element to be totally reflected (refracted), so as to increase the illuminating brightness of an illuminating device.

To achieve the above and other objects, the light condensing structure for illuminating device according to the present invention includes a lamp shade; an optical unit located at an open end of the lamp shade and provided on one of two opposite sides with a plurality of concentric annular light condensing sections, each of which has an upward tapered cross-sectional shape; and a light-emitting element mounted in the lamp shade to face toward the other side of the optical unit.

Divergent lights from the light-emitting element can be totally reflected (refracted) by the light condensing sections of the optical unit, so that an increased illuminating brightness can be achieved for the illuminating device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing a light condensing structure for illuminating device according to an embodiment of the present invention;

FIG. 2 is a vertical sectional view of FIG. 1; and

FIG. 3 shows how lights are reflected and condensed by the light condensing structure of the present invention.

### DETAILED DESCRIPTION OF THE PREFERRED EMBODIMENTS

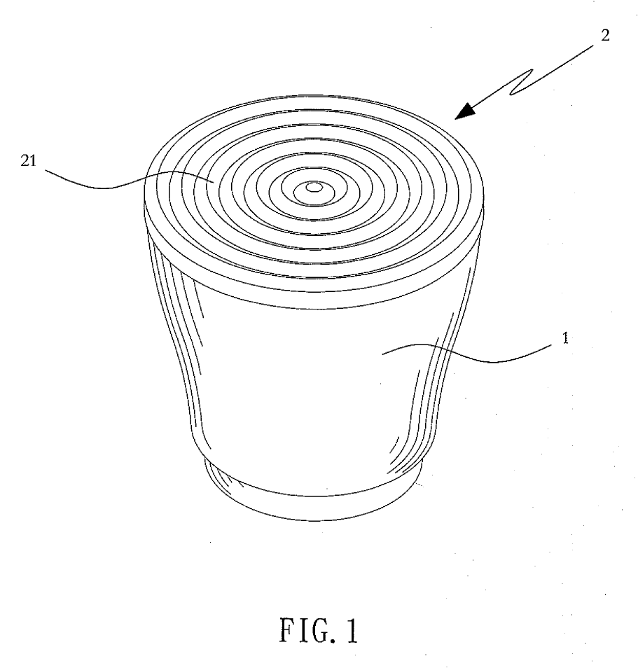

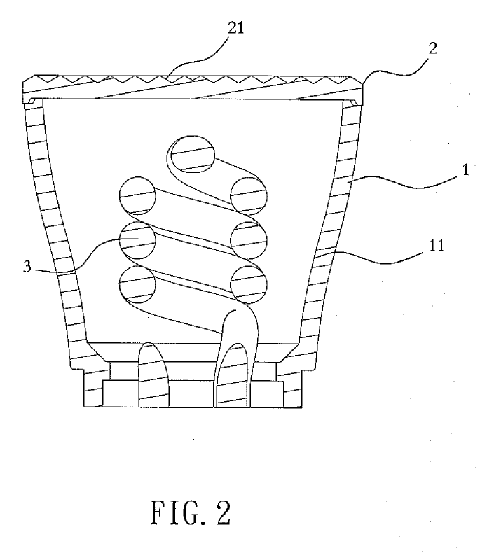

Please refer to FIGS. 1 and 2 that are perspective and vertical sectional views, respectively, showing a light condensing structure for illuminating device according to an embodiment of the present invention. As shown, the light condensing structure includes a lamp shade 1, an optical unit 2, and a light-emitting element 3.

The lamp shade 1 has an inner wall surface, which is a reflecting surface 11.

The optical unit 2 is located at an open end of the lamp shade 1, and can be made of a light-transmittable and reflecting material and can have glossy or frosted faces. The optical unit 2 is provided on one of two opposite sides with a plurality of concentric annular light condensing sections 21. Each of the light condensing sections 21 has an upward tapered cross-sectional shape. A vertex angle of the upward tapered light condensing section 21 is preferably between 90° and 140°, and most preferably 120°.

The light-emitting element 3 is mounted in the lamp shade 1 to face toward the other side of the optical unit 2. The light-emitting element 3 can be a screw-in bulb or a light emitting diode (LED) bulb.

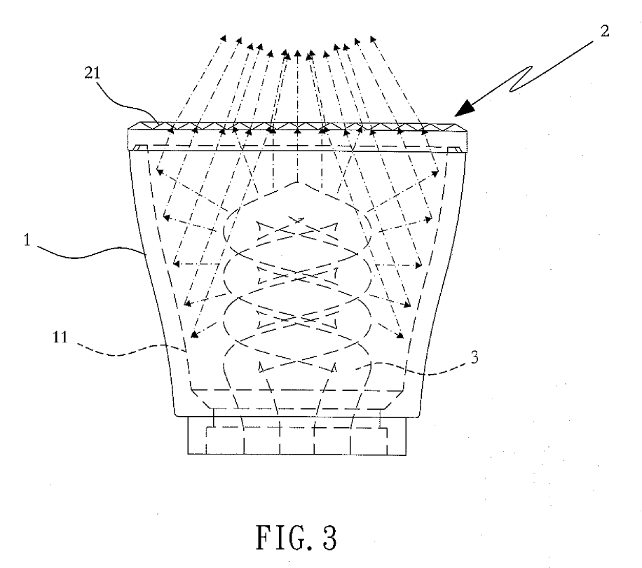

FIG. 3 shows how the lights emitted from the light-emitting element 3 are reflected by the reflecting inner surface 11 of the lamp shade 1 and then condensed by the light condensing sections 21 of the optical unit 2 according to the light condensing structure of the present invention. As shown, when the light-emitting element 3 emits lights, the emitted lights are either directly irradiated on the optical unit 2 or reflected by the reflecting inner surface 11 of the lamp shade 1 toward the optical unit 2. The lights irradiated on or reflected toward the optical unit 2 are refracted by the light condensing sections 21 and then projected to an environment outside the optical unit 2 as a result of total reflection phenomenon. That is, when the lights from the light-emitting element 3 travel through the optical unit 2, the lights are condensed by the light condensing sections 21 of the optical unit 2 as a result of total reflection (refraction), so that the light-emitting element 3 provides an increased illuminating brightness.

With the light condensing structure for illuminating device according to the present invention, divergent lights from the light-emitting element are totally reflected (refracted) by the light condensing sections of the optical unit to thereby increase the illuminating brightness of the illuminating device, making the illuminating device more practical for use.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A light condensing structure for illuminating device, comprising:
a lamp shade;
an optical unit located at an open end of the lamp shade and being provided on one of two opposite sides with a plurality of concentric annular light condensing sections; and each of the light condensing sections having an upward tapered cross-sectional shape; and
a light-emitting element being mounted in the lamp shade to face toward the other side of the optical unit.

2. The light condensing structure for illuminating device as claimed in claim 1, wherein the lamp shade has an inner wall surface, which is a reflecting surface.

3. The light condensing structure for illuminating device as claimed in claim 1, wherein the optical unit is made of a light-transmittable and reflecting material.

4. The light condensing structure for illuminating device as claimed in claim 1, wherein the optical unit can have glossy faces or frosted faces.

5. The light condensing structure for illuminating device as claimed in claim 1, wherein each of the upward tapered light condensing sections has a vertex angle, which is ranged between 90° and 140°, and is most preferably 120°.

6. The light condensing structure for illuminating device as claimed in claim 1, wherein the light-emitting element is selected from the group consisting of a screw-in bulb and a light emitting diode (LED) bulb.
